(19) United States
(12) Patent Application Publication
(10) Pub. No.: US 2005/0110935 A1
(43) Pub. Date: May 26, 2005

(54) Semiconductor chip, tape carrier package having the same mounted thereon, and liquid crystal display apparatus including the tape carrier package

(76) Inventors: Dong-Han Kim, Osan-si (KR); Sa-Yoon Kang, Dongjak-gu (KR)

Correspondence Address: HARNESS, DICKEY & PIERCE, P.L.C., P.O. BOX 8910, RESTON, VA, 20195, US

(21) Appl. No.: 10/947,220

(22) Filed: Sep. 23, 2004

(30) Foreign Application Priority Data
Nov. 26, 2003 (KR) 2003-84582

(51) Int. Cl. G02F 1/1345; G02F 1/1343

(52) U.S. Cl. 349/150; 349/139; 349/151

(57) ABSTRACT

A semiconductor chip, a TCP on which the semiconductor chip may be mounted, and/or an LCD apparatus which may include the TCP may be reduced in size by reducing the circuit patterns which may pass through the base film and bypass patterns which may be formed in wiring patterns within the chip. The size and/or manufacturing costs of the TCP and LCD apparatus may be reduced by changing circuit patterns which may pass through the base film.

### CROSS-REFERENCE TO RELATED APPLICATIONS

This application claims priority of Korean Patent Application No. 10-2003-0084582 filed on Nov. 26, 2003 in the Korean Intellectual Property Office, the disclosure of which is incorporated herein by reference.

### FIELD OF THE INVENTION

Exemplary embodiments of the present invention relate to a liquid crystal display (LCD) apparatus which may not require a board (for example, a gate printed circuit board (PCB) or a flexible PCB), and more particularly, to a semiconductor chip, which may reduce the size of a base film, a tape carrier package (for example, a gate (TCP)), and a display device (for example, a liquid crystal display (LCD)), such that input and output patterns may be connected to each other within the chip by altering the structure of the input pad or pads. Bypass patterns, which may be formed in wiring patterns within the chip may reduce the circuit patterns which may pass through the base film. Exemplary embodiments of the present invention may also relate to a TCP on which the semiconductor chip may be mounted, and an LCD apparatus including the TCP.

### DESCRIPTION OF THE CONVENTIONAL ART

Most existing TCPs may have a structure suitable for connection between an LCD panel and a board (for example, an integrated printed circuit board (PCB)). TCPs such as gate TCPs may not accommodate today's LCD structures from which a gate board may be removed.

As shown in FIG. 1, three gate TCPs 120 may be connected to an LCD panel 110. Lower substrate 111 and an upper substrate 112 may constitute the LCD panel 110. Signal transmission lines 101a-101d, and gate lines 126 may be formed on the lower substrate 111. The conventional LCD apparatus may include the LCD panel 110, the gate TCP 120, a source TCP (not shown), and an integrated PCB (not shown).

Each gate TCP 120 may include a base film 121, which may be made of an insulating material and may include input patterns 122, first output patterns 123, second output patterns 124, and bypass patterns 125, which may be formed on a surface of the base film 121. The gate TCP 120 may also include a gate driving semiconductor chip 140 which may be electrically connected to the input patterns 122 and the first and second output patterns 123 and 124. The gate driving semiconductor chip 140 may be a flip-chip and may be mounted on the base film 121.

As shown in FIGS. 1 and 2, the input patterns 122 may turn around a first side (shown in FIG. 3) of the gate driving semiconductor chip 140 on the base film 121. Input ends of the input patterns 122 may be electrically connected to the first gate driving signal transmission lines 101a on the lower substrate 111. Output ends of the input patterns 122 may be electrically connected to the input pads 142 of the gate driving semiconductor chip 140, while other output ends of the input patterns 122 may be electrically connected to the bypass patterns 125.

The first output patterns 123 may be arranged at a third side (shown in FIG. 3) which may be perpendicular or substantially perpendicular to the first side of the gate driving semiconductor chip 140 in a line on the base film 121. Input ends of the first output patterns 123 may be electrically connected to the output pads 143 of the gate driving semiconductor chip 140, and output ends of the first output patterns 123 may be electrically connected to the gate lines 126, on the lower substrate 111.

The second output patterns 124 may turn around a second side (shown in FIG. 3) which may be parallel with, or substantially parallel to, the first side of the gate driving semiconductor chip 140 in a line on the base film 121. Input ends of the second output patterns 124 may be electrically connected to input pads 142 of the gate driving semiconductor chip 140, and output ends of the second output patterns 124 may be electrically connected to the second gate driving signal transmission lines 101b, on the lower substrate 111.

The bypass patterns 125 may be arranged to be parallel or substantially parallel to a fourth side (shown in FIG. 3) and may be perpendicular or substantially perpendicular to the first side of the gate driving semiconductor chip 140 in lines on the base film 121. Input ends of the bypass patterns 125 may contact output ends of the input patterns 122, and output ends of the bypass patterns 125 may contact input ends of the second output patterns 124.

As shown in FIG. 3, the gate driving semiconductor chip 140 may include a main body 141 and a plurality of the input and output pads 142 and 143. The input pads 142 may be arranged in a line at the third side of the main body 141, and the output pads 143 may be arranged in a line at the fourth side of the main body 141 such that the input pads 142 may face the output pads 143.

The input pads 142 may be divided into at least two groups based on a position on the main body 141.

As shown in FIG. 3 the input pads 142 may be divided into two groups A and B. The input pads 142 in the group A may be electrically connected to the input patterns 122, and the input pads 142 in the group B may be electrically connected to the second output patterns 124. All of the output pads 143 may be electrically connected to the first output patterns 123.

The input pads 142 in group A may be electrically connected with the input pads 142 in group B in one-to-one correspondence via a core circuit 144 which may be incorporated in the gate driving semiconductor chip 140. Input pads 142 may be electrically connected to each other in one-to-one correspondence via the core circuit 144.

The input pads 142 may be arranged to face the output pads 143 along the fourth side of the gate driving semiconductor chip 140, and may increase the width “w” of the gate driving semiconductor chip 140.

The input patterns 122, the bypass patterns 125, and the second output patterns 124 may be arranged to turn around the first, fourth, and second sides, respectively, of the gate driving semiconductor chip 140 which may increase the length of the base film 121. An increase in the size of the base film 121, may cause the overall size of the gate TCP 120 to increase. Further, the amount of film used and/or the material cost may increase.

### SUMMARY OF THE INVENTION

Exemplary embodiments of the present invention may provide a semiconductor chip which may have a structure in which input and output patterns may be connected within the semiconductor chip such that input pads may be interconnected at first and second sides of the semiconductor chip, and bypass patterns may be formed in wiring patterns within the semiconductor chip.

Exemplary embodiments of the present invention may also provide a tape carrier package (for example a gate tape carrier package (TCP)) which may reduce the circuit patterns passing through a base film by manufacturing a TCP which may use a semiconductor chip similar to those in the above-described exemplary embodiments.

Exemplary embodiments of the present invention may also provide a display apparatus (for example, a liquid crystal display (LCD)) which may employ a TCP, similar to those in the above-described exemplary embodiments, in manufacturing an LCD panel assembly.

In an exemplary embodiment of the present invention, there may be provided a semiconductor chip which may include a main body, which may have a built-in core circuit, first input pads which may be arranged at a first side of the main body, second input pads which may be arranged at a second side of the main body, output pads which may be arranged at a third side of the main body, and bypass patterns which may be formed within the main body and may transmit (for example, directly transmit) driving signals, which may be transmitted through the first input pads to the second input pads, without passing through the core circuit.

The bypass patterns may be arranged in a line which may be parallel or substantially parallel to a fourth side and perpendicular or substantially perpendicular to a first side of the core circuit. The first input pads may be electrically connected to the second input pads in one-to-one correspondence.

The semiconductor chip may further comprise first wiring patterns, which may be formed within the main body and may input driving signals which may be transmitted through the first input pads to the core circuit, and second wiring patterns which may be formed within the main body and may output driving signals that may not have been processed by the core circuit through the second input pads.

The first wiring patterns may turn (i.e. bend at an angle of 90 degrees) around the first side of the core circuit in a line, and the second wiring patterns may turn (i.e. bend at an angle of 90 degrees) around a second side of the core circuit in a line.

The first wiring patterns may be arranged in a line which may be perpendicular or substantially perpendicular to the first side of the core circuit, and the second wiring patterns may be arranged in a line which may be perpendicular or substantially perpendicular to a second side of the core circuit.

In another exemplary embodiment of the present invention, there may be provided a TCP which may comprise a base film made of an insulating material, a semiconductor chip which may be mounted on the base film, input patterns which may be formed on the base film and may be connected to the first input pads of the semiconductor chip, first output patterns which may be formed on the base film and may be connected to the output pads of the semiconductor chip, and second output patterns which may be formed on the base film which may be connected to the second input pads of the semiconductor chip. The semiconductor chip may comprises a main body which may have a built-in core circuit, first input pads which may be arranged at a first side of the main body, second input pads which may be arranged at a second side of the main body, output pads which may be arranged at a third side of the main body, and bypass patterns which may be formed within the main body, may transmit (for example, directly transmit) driving signals through the first input pads to the second input pads, and may not pass through the core circuit.

The bypass patterns may be arranged in a line which may be parallel or substantially parallel to a fourth side and may be perpendicular or substantially perpendicular to a first side of the core circuit. The first input pads may be electrically connected to the second input pads in one-to-one correspondence.

The semiconductor chip may further comprise first wiring patterns which may be formed within the main body and may input driving signals transmitted through the first input pads to the core circuit, and second wiring patterns which may be formed within the main body and may output driving signals that may not have been processed by the core circuit through the second input pads.

The first wiring patterns may turn (i.e. bend at an angle of 90 degrees) around the first side of the core circuit in a line and the second wiring patterns may turn (i.e. bend at an angle of 90 degrees) around a second side of the core circuit in a line.

The first wiring patterns may be arranged in a line and may be perpendicular or substantially perpendicular to the first side of the core circuit, and the second wiring patterns may be arranged in a line which may be perpendicular or substantially perpendicular to a second side and may be parallel or substantially parallel to the first side of the core circuit.

In another exemplary embodiment of the present invention, there may be provided an LCD apparatus which may comprise an LCD panel, a board (for example, an integrated printed circuit board (PCB)), and at least two tape carrier packages (TCPs). The LCD panel may comprise an upper substrate and a lower substrate which may include gate lines, data lines, and signal transmission lines which may transmit gate driving signals. The board may be disposed at one side of the liquid crystal display panel and may generate gate driving signals and data driving signals. The at least one gate TCP may have one end thereof connected to the data lines of the lower substrate, and another end thereof connected to the board. The at least one TCP may be disposed at another side of the liquid crystal display panel, and may have one end thereof connected to the gate lines of the lower substrate. The other of the at least two TCPs and the semiconductor chip mounted thereon may be substantially the same as those in the above-described embodiment.

The input patterns and the second output patterns may be connected to each other through the first and second wiring patterns within the gate driving semiconductor chip, circuit patterns which may pass through the base film may be reduced, and the size of the base film may be reduced. Further, the input pads may be divided into the first and/or second sides of the gate driving semiconductor chip, and the width of the gate driving semiconductor chip may be reduced.

In another exemplary embodiment of the present invention a semiconductor chip may comprise a main body, which may include a built-in core circuit, first input pads which may be arranged at a first side of the main body, second input pads which may be arranged at a second side of the main body, and output pads which may be arranged at a third side of the main body.

The first input pads may be electrically connected to the second input pads in one-to-one correspondence.

The semiconductor chip may further comprise first wiring patterns which may be formed within the main body and may input driving signals transmitted through the first input pads to the core circuit; and second wiring patterns which may be formed within the main body and may output driving signals that may not have been processed by the core circuit through the second input pads.

The first wiring patterns may turn (i.e. bend at an angle of 90 degrees) around the first side of the core circuit in a line and the second wiring patterns may turn (i.e. bend at an angle of 90 degrees) around a second side which may be parallel or substantially parallel to the first side of the core circuit in a line.

The first wiring patterns may be arranged in a line and may be perpendicular or substantially perpendicular to the first side of the core circuit, and the second wiring patterns may be arranged in a line which may be perpendicular or substantially perpendicular to a second side and may be parallel or substantially parallel to the first side of the core circuit.

In another exemplary embodiment of the present invention, there may be provided a tape carrier package which may comprise a base film which may be made of an insulating material, a semiconductor chip which may be mounted on the base film, bypass patterns which may be formed on the base film in a line, may be parallel or substantially parallel to a fourth side, and may be perpendicular or substantially perpendicular to the first side of the semiconductor chip, input patterns which may be formed on the base film and may be connected to the first input pads of the semiconductor chip and one end of the bypass patterns, first output patterns which may be formed on the base film and may be connected to the output pads of the semiconductor chip, and second output patterns which may be formed on the base film and may be connected to the second input pads of the semiconductor chip and the other end of the bypass patterns. The semiconductor chip may comprise a main body which may have a built-in core circuit, first input pads which may be arranged at a first side of the main body, second input pads which may be arranged at a second side which may be parallel or substantially parallel to the first side of the main body, and output pads which may be arranged at a third side which may be perpendicular or substantially perpendicular to the first side of the main body.

The first input pads may be electrically connected to the second input pads in one-to-one correspondence.

The semiconductor chip may further comprise first wiring patterns which may be formed within the main body and may input driving signals which may be transmitted through the first input pads to the core circuit; and second wiring patterns which may be formed within the main body and may output driving signals that may not have been processed by the core circuit through the second input pads.

The first wiring patterns may turn (i.e. bend at an angle of 90 degrees) around a first side of the core circuit in a line and the second wiring patterns may turn (i.e. bend at an angle of 90 degrees) around a second side which may be parallel or substantially parallel to the first side of the core circuit in a line.

The first wiring patterns may be arranged in a line which may be perpendicular or substantially perpendicular to a first side of the core circuit, and the second wiring patterns may be arranged in a line which may be perpendicular or substantially perpendicular to a second side and may be parallel or substantially parallel to the first side of the core circuit.

In another exemplary embodiment of the present invention, there may be provided a liquid crystal display apparatus which may include structures of a TCP and a semiconductor chip, which may be mounted thereon.

Bypass patterns may be formed on the base film, input patterns and the second output patterns may be connected to each other through the first and second wiring patterns within the gate driving semiconductor chip, and the size of the base film may be reduced. The input pads may be divided into the first and second sides of the chip and may be arranged thereat, which may reduce the width of the chip.

### BRIEF DESCRIPTION OF THE DRAWINGS

The above and other features and advantages of the present invention may become more apparent by describing in detail exemplary embodiments thereof with reference to the attached drawings in which:

FIG. 1 is a partial perspective view of a conventional liquid crystal display (LCD) apparatus;

FIG. 2 is an enlarged and exploded perspective view of part I shown in FIG. 1;

FIG. 3 is an enlarged perspective view of a gate tape carrier package (TCP) shown in FIG. 1;

FIG. 4 is a perspective view of an LCD apparatus according to an exemplary embodiment of the present invention;

FIG. 5 is an enlarged and exploded perspective view of an example part I shown in FIG. 4;

FIGS. 6A and 6B are both enlarged perspective views of exemplary embodiments of the TCP shown in FIG. 4;

FIG. 7 is a perspective view of an LCD apparatus according to another embodiment of the present invention;

FIG. 8 is an enlarged and exploded perspective view of an example part I shown in FIG. 7; and

FIGS. 9A and 9B are both enlarged perspective views of examples of an example gate TCP shown in FIG. 7.

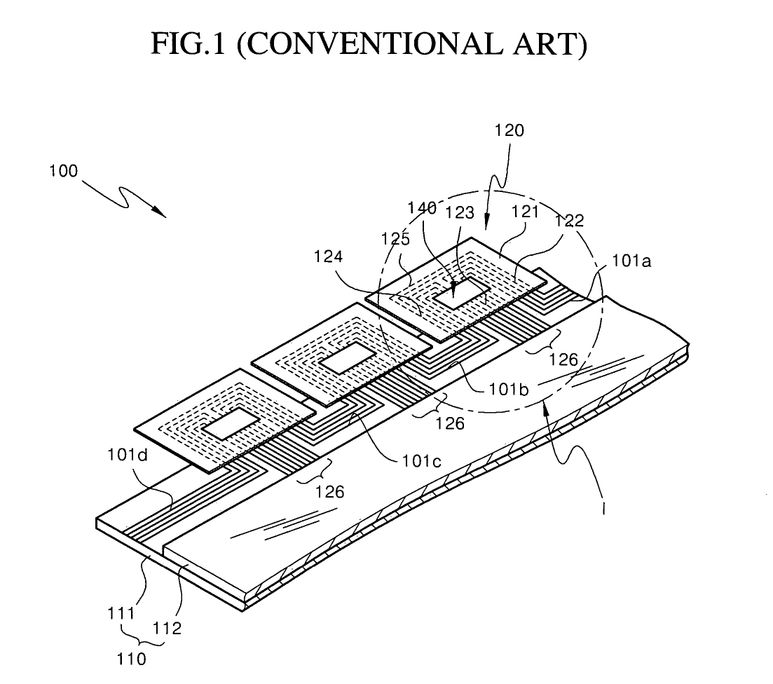

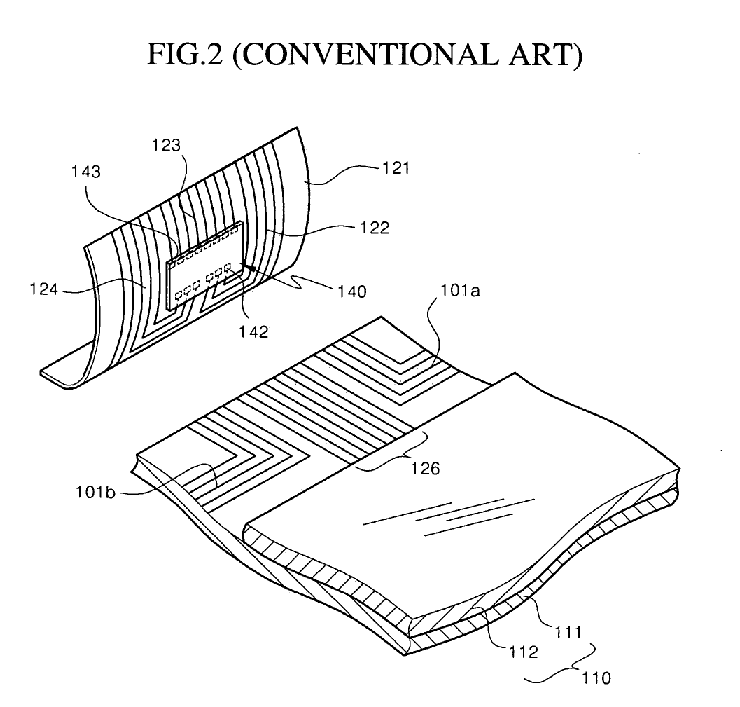

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may be embodied in many different forms and should not be construed as being limited to the exemplary embodiments set forth herein. These exemplary embodiments may be provided such that this disclosure will be thorough and complete and will fully convey the concept of the invention to those skilled in the art. Like reference numerals refer to like elements throughout the specification.

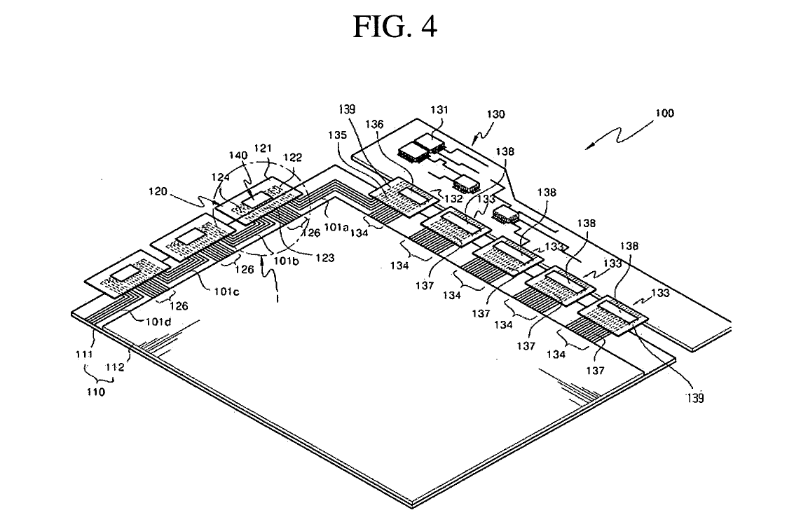

Referring to FIG. 4, in an exemplary embodiment of the present invention, an LCD apparatus 100 may include an LCD panel 110, gate tape carrier packages (TCPs) 120, source TCPs 132 and 133, and a board 130 (for example, an integrated printed circuit board (PCB)).

The LCD panel 100 may include a lower substrate 111 and an upper substrate 112. The lower substrate 111 may include gate lines 126, data lines 134, thin-film transistors, and pixel electrodes. The upper substrate 112 may be stacked on the lower substrate 111 and may face the lower substrate 111. The upper substrate 112 may be smaller than the lower substrate and may include black matrices, color pixels, and electrodes. Liquid crystals (not shown) may be interposed between the upper substrate 112 and the lower substrate 111.

The gate TCPs 120 may be connected to the gate lines 126 which may be formed on the lower substrate 111. The source TCPs 132 and 133 may be connected to the data lines 134 which may be formed on the lower substrate 111.

The board 130 may include a plurality of driving parts 131. The driving parts 131 may input gate driving signals to the gate TCPs 120 and data driving signals to the source TCPs 132 and 133.

The gate lines 126 may be spaced in an effective display area in which an image may be displayed. In a non-effective display area, which may correspond to an edge of the lower substrate 111, the gate lines 126 may be divided into three groups as shown in FIG. 4, wherein the gate lines 126 may be spaced and may connect to the gate TCPs 120.

The data lines 134 may be spaced in the effective display area in which an image may be displayed. In the non-effective display area, which may correspond to the edge of the lower substrate 111, the data lines 134 may be divided into five groups as shown in FIG. 4, wherein the gate lines 126 may be spaced and may connect to the source TCPs 132 and 134.

First gate driving signal transmission lines 101a may be disposed at a corner between the source TCP 132 and a gate TCP 120 that may be closer to the source TCP 132 on the lower substrate 111. One end of the first gate driving signal transmission lines 101a may extend towards the data lines 134, and another end of the first gate driving signal transmission lines 101a may extend towards the gate lines 126.

Second through fourth gate driving signal transmission lines 101b, 101c, and 101d, which may be separated from the first gate driving signal transmission lines 101a, may be disposed among the groups of the gate lines 126. The second through fourth gate driving signal transmission lines 101b, 101c, and 101d may extend from a side of the lower substrate 111, may be in parallel with, or substantially parallel to, the gate lines 126, may bend at an angle of 90 degrees two times, and may extend to the side of the lower substrate 111 which may be in parallel with, or substantially parallel to, the gate lines 126.

The source TCPs 132 and 133 may be divided into a combined gate and data driving signal TCP 132 and/or a data driving signal TCPs 133.

The combined gate and data driving signal TCP 132 may include a plurality of driving signal transmission patterns 135 and a data driving semiconductor chip 136 electrically connecting to driving signal transmission patterns 135. The data driving semiconductor chip 136 may be mounted on a base film 139 in a flip-chip manner. Some of the driving signal transmission patterns 135 may not connect to the data driving semiconductor chip 136 but may connect to the first gate driving signal transmission lines 101a on the lower substrate 111, and transmit gate driving signals from the integrated board 130 to the gate TCP 120. Driving signal transmission patterns 135 may connect to the data driving semiconductor chip 136 and the corresponding data lines 134 on the lower substrate 111, and may transmit data driving signals from the integrated board 130 to the thin-film transistors.

Each exclusive data driving signal TCP 133 may include a plurality of driving signal transmission patterns 137 and a data driving semiconductor chip 138 which may electrically connect to the driving signal transmission patterns 137. The data driving semiconductor chip 138 may be mounted on the base film 139 in a flip-chip manner.

Each gate TCP 120 may include a base film 121 which may be made of an insulating material, input patterns 122, first output patterns 123, and second output patterns 124, which may be formed on one surface of the base film 121. The gate TCP 120 may also include a gate driving semiconductor chip 140 which may electrically connect to the input patterns 122 and the first and second output patterns 123 and 124. The gate driving semiconductor chip 140 may be mounted on the base film 121 in a flip-chip manner.

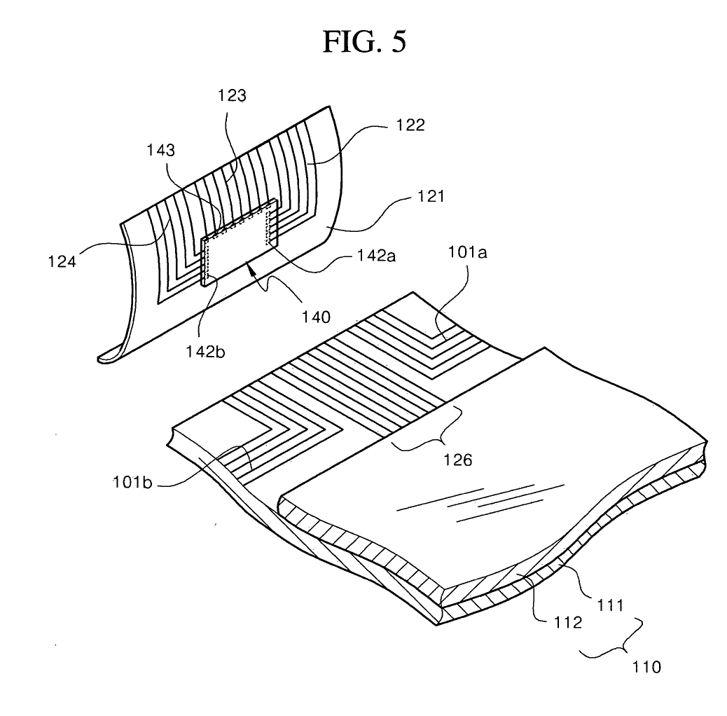

Referring to FIG. 5, the gate TCP 120 may be mounted on the lower substrate 111 of the LCD panel 110. Signal transmission patterns, which may be formed on the base film 121 of the gate TCP 120, may be connected to signal transmission patterns which may be formed on the lower substrate 111 of the LCD panel 110.

The input patterns 122 may turn around a first side of the gate driving semiconductor chip 140 in a line on the base film 121. Input ends of the input patterns 122 may electrically connect to the signal transmission lines, i.e., the first gate driving signal transmission lines 101a on the lower substrate 111. Output ends of the input patterns 122 may electrically connect to the first input pads 142a of the gate driving semiconductor chip 140.

The first output patterns 123 may be arranged at a third side which may be perpendicular or substantially perpendicular to the first side of the gate driving semiconductor chip 140 in a line on the base film 121. Input ends of the first output patterns 123 may electrically connect to the output pads 143 of the gate driving semiconductor chip 140, and output ends of the first output patterns 123 may electrically connect to the gate lines 126 on the lower substrate 111.

The second output patterns 124 may turn around a second side which may be parallel or substantially parallel to the first side of the gate driving semiconductor chip 140 in a line on the base film 121. Input ends of the second output patterns 124 may electrically connect to the second input pads 142b of the gate driving semiconductor chip 140, and output ends of the second output patterns 124 may electrically connect to the second gate driving signal transmission lines 101b on the lower substrate 111.

The gate driving semiconductor chip 140, the input patterns 122, the first output patterns 123, and the second output patterns 124, may be formed on one surface of the base film 121.

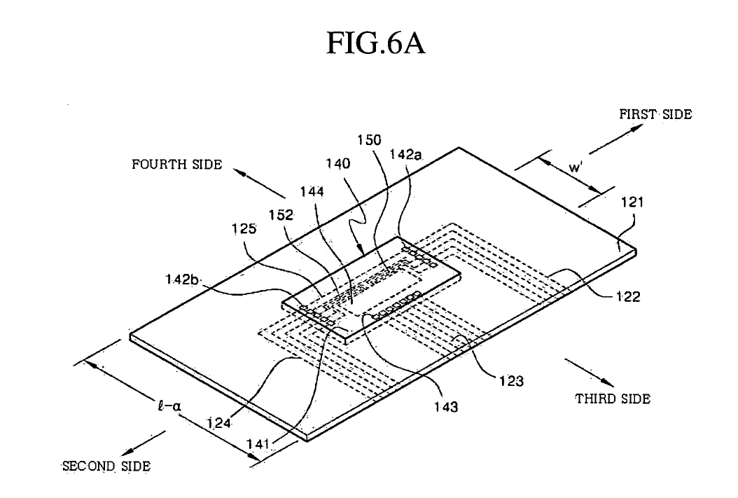

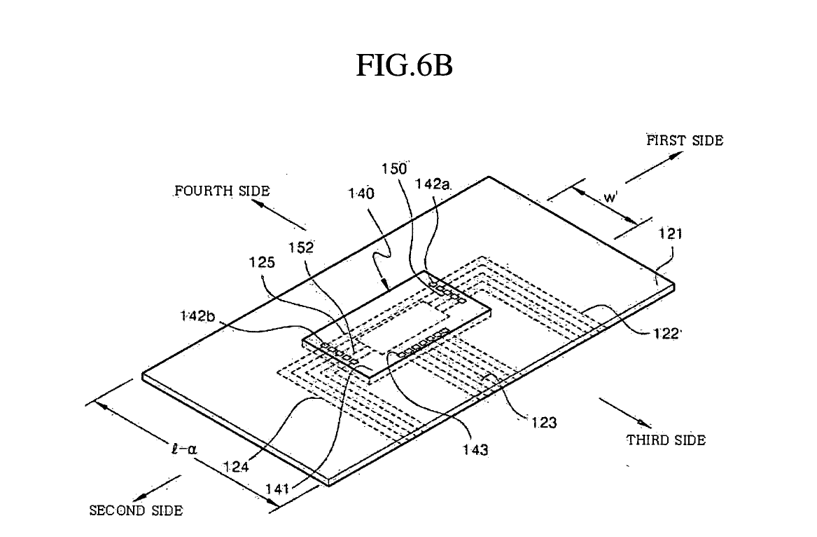

Referring to FIGS. 6A and 6B, a gate driving semiconductor chip 140 may include a main body 141 which may include a core circuit 144, first input pads 142a which may be formed in a line at the first side of the main body 141, second input pads 142b which may be formed in a line at the second side parallel or substantially parallel to the first side of the main body 141, output pads 143 which may be formed in a line at the third side perpendicular or substantially perpendicular to the first side of the main body 141, and bypass patterns 125 which may transmit (for example, directly transmit) driving signals through the first input pads 142a to the second input pads 142b without passing through the core circuit 144.

The first input pads 142a, which may be arranged at the first side of the main body, may electrically connect to the input patterns 122, and the second input pads 142b may be electrically connected to the second output patterns 124. The output pads 143 may electrically connect to the first output patterns 123 without being divided.

The first input pads 142a may be electrically connected to the second input pads 142b in one-to-one correspondence. The first input pads 142a and the second input patterns 142b may be formed in the same arrangement on opposite sides of the main body, i.e. a mirror structure. A first input pad 142a and a second input pad 142b, which may be connected by the core circuit 144 and which may be installed within the gate driving semiconductor chip 140, may output the same type of signal.

First wiring patterns 150 and/or second wiring patterns 152 may be disposed within the main body 141. The first wiring patterns 150 may input gate driving signals which may be transmitted through the first input pads 142a to the core circuit 144. The second wiring patterns 152 may output gate driving signals which may not have been processed by the core circuit 144 through the second output pads 142b.

As shown in FIG. 6A, the first wiring patterns 150 may be arranged to turn around the first side of the core circuit 144 in a line, and the second wiring patterns 152 may be arranged to turn around the second side parallel or substantially parallel to the first side of the core circuit 144 in a line. As shown in FIG. 6B, the first wiring patterns 150 may be arranged perpendicular or substantially perpendicular to the first side of the core circuit 144 in a line, and the second wiring patterns 152 may be arranged perpendicular or substantially perpendicular to the second side and parallel or substantially parallel to the first side of the core circuit 144 in a line.

As shown in FIG. 4, in an LCD apparatus, upon receiving an image signal output from a computer, the board 130 may generate gate driving signals and/or data driving signals in response to the image signal. The data driving signals, which may be generated by the board 130, may be input to the data driving semiconductor chips 136 and 138 via the driving signal transmission patterns 135, which may be formed on the combined gate and data driving signal TCP 132, and via the driving signal transmission patterns 137 on the data driving signal TCPs 133. The data driving signals may be processed by the data driving semiconductor chips 136 and 138. Data driving signals, may be input to the data lines 134 on the lower substrate 111 via the driving signal transmission patterns 135 and 137. The gate driving signals, which may be generated by the board 130, may be input to the first gate driving signal transmission lines 101a on the lower substrate 111 via the driving signal transmission patterns 135, which may be formed on the combined gate and data driving signal TCP 132.

The gate driving signals which may be input to the first gate driving signal transmission lines 101a may be input to the first input pads 142a shown in FIGS. 6A and 6B via the input patterns 122. The gate driving signals which may be input to the first input pads 142a may be transmitted to an adjacent gate TCP 120 and may not pass through the core circuit 144 via the bypass patterns 125, the second input pads 142b, and the second output patterns 124. The gate driving signals may be input to the core circuit 144 within the gate driving semiconductor chip 140 via the first wiring patterns 150.

The gate driving signals, which may be input to the core circuit 144 within the gate driving semiconductor chip 140, may be converted into output signals by the core circuit 144, and the output signals may be transmitted to the gate lines 126 on the lower substrate 111, the output pads 143, and the first output patterns 123. Gate driving signals that may not have been processed by the core circuit 144 may be transmitted to the second input pads 142b via the second wiring patterns 152.

The gate driving signals, which may be transmitted to the second input pads 142b, may be output to the second gate driving signal transmission lines 101b and may drive the adjacent gate TCP 120. The gate driving signals, which may be output to the second gate driving signal transmission lines 101b, may flow along the input patterns 122, the first input pads 142a, the second input pads 142b, and the second output patterns 124, in each of the other gate TCPs 120, which may be formed in a line along the edge of the lower substrate 111.

The gate driving signals may be transmitted from the board 130 to the gate driving semiconductor chips 140 of the respective gate TCPs 120.

The gate output signals may be applied to the gate lines 126 on the lower substrate 111 through the above-described procedure, and the thin-film transistors in a column may be turned on in response to the gate output signals. Voltages which may have been applied to the data driving semiconductor chips 136 and 138 may be output to the pixel electrodes, and electric fields may be formed among the pixel electrodes and/or the common electrodes. The arrangement of the liquid crystals which may be interposed between the upper substrate 112 and the lower substrate 111 may be changed and image information may be displayed.

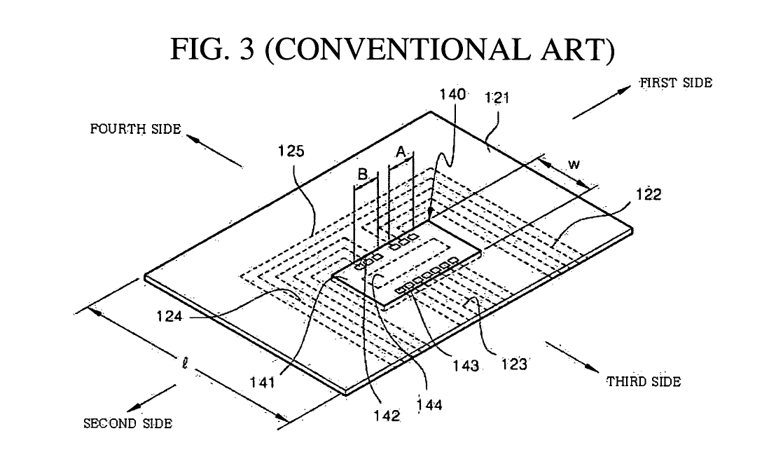

The first and second input pads 142a and 142b may be divided into the first and second sides of the gate driving semiconductor chip 140, and input pads may or may not be arranged at the fourth side which may face the third side of the gate driving semiconductor chip 140 where the output pads 143 may be formed. Thus, the width “w” and/or the manufacturing costs of the gate driving semiconductor chip 140 shown in FIG. 3 may be reduced. The bypass patterns 125 may be disposed within the gate driving semiconductor chip 140, and the input patterns 122 and the second output patterns 124, which may be disposed on the base film 121, may be connected to each other through the first and/or second wiring patterns 150 and 152 within the gate driving semiconductor chip 140, and may reduce the circuit patterns which may pass through the base film 121. Thus, a width “l” of the base film 121 shown in FIG. 3 may be reduced as shown in FIGS. 6A and 6B, and the size of a display device, the amount film used, and/or manufacturing costs may be reduced.

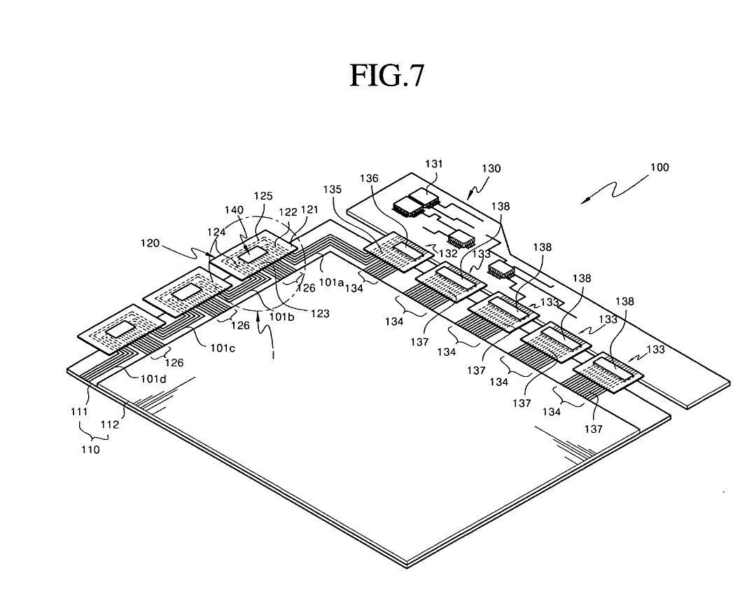

In another exemplary embodiment of the present invention, the basic structure of the LCD apparatus shown in FIG. 7 may be the same as that of the LCD apparatus shown in FIG. 4.

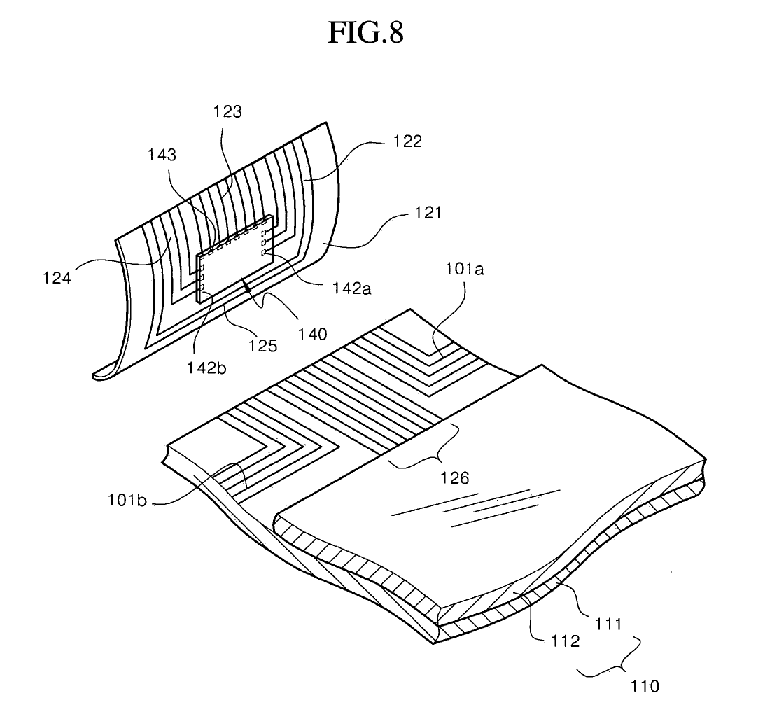

As shown in FIGS. 7 and 8, each gate TCP 120 may include a base film 121 which may be made of an insulating material, input patterns 122, first output patterns 123, second output patterns 124, and bypass patterns 125 which may be formed on one surface of the base film 121. The gate TCP 120 may include a gate driving semiconductor chip 140 which may be electrically connected to the input patterns 122 and the first and second output patterns 123 and 124. The gate driving semiconductor chip 140 may be mounted on the base film 121 in a flip-chip manner.

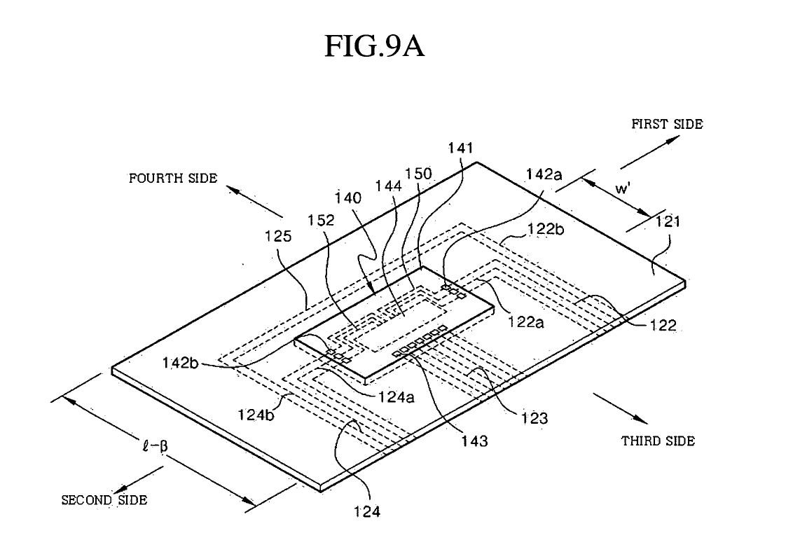

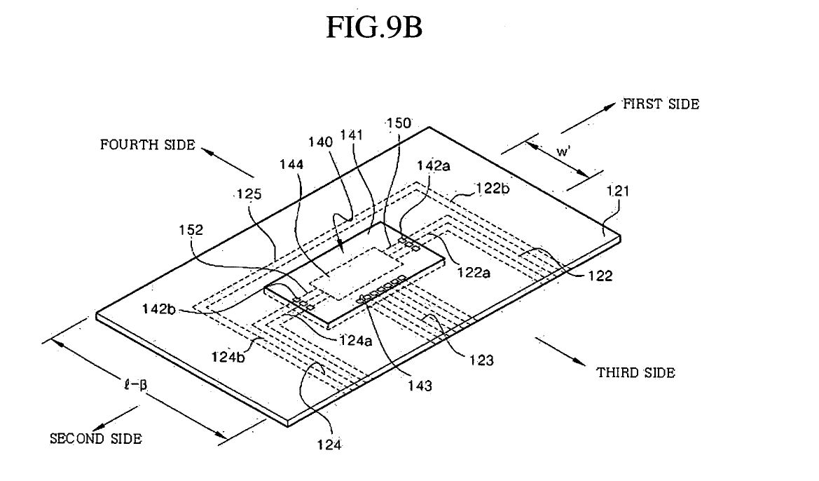

The input patterns 122 may be divided into two groups 122a and 122b (shown in FIGS. 9A and 9B) according to the function of the output ends and may be arranged at a first side of the gate driving semiconductor chip 140 on the base film 121. The input patterns in the group 122a may turn toward the first side of the gate driving semiconductor chip 140, and the input patterns in the group 122b may turn around the first side of the gate driving semiconductor chip 140. Input ends of the input patterns 122 may be electrically connected to the first gate driving signal transmission lines 101a on a lower substrate 111. Output ends of the input patterns in the group 122a may be electrically connected to the first input pads 142a of the gate driving semiconductor chip 140, and output ends of the input patterns in the group 122b may connect to the input ends of the bypass patterns 125.

The first output patterns 123 may be arranged at a third side which may be perpendicular or substantially perpendicular to the first side of the gate driving semiconductor chip 140 in a line on the base film 121. Input ends of the first output patterns 123 may electrically connect to the output pads 143 of the gate driving semiconductor chip 140, and output ends of the first output patterns 123 may electrically connect to the gate lines 126, on the lower substrate 111.

The second output patterns 124 may be divided into two groups 124a and 124b (shown in FIGS. 9A and 9B) according to the function of the input ends and may be arranged at a second side of the gate driving semiconductor chip 140 on the base film 121. The second output patterns in the group 124a may turn toward the second side of the gate driving semiconductor chip 140, and the second output patterns in the group 124b may turn around the second side of the gate driving semiconductor chip 140. Input ends of the second output patterns in the group 124a may be electrically connected to the second input pads 142b of the gate driving semiconductor chip 140, and input ends of the second output patterns in the group 124b may be connected to the output ends of the bypass patterns 125. Output ends of the second output patterns 124 may be electrically connected to the second gate driving signal transmission lines 101b on the lower substrate 111.

The bypass patterns 125 may be arranged on the base film 121 and may be parallel or substantially parallel to the fourth side and perpendicular or substantially perpendicular to the first side of the gate driving semiconductor chip 140. The input ends of the bypass patterns 125 may be connected to the output ends of the input patterns in the group 122b, and the output ends of the bypass patterns 125 may connect to the input ends of the second output patterns in the group 124b.

The gate driving semiconductor chip 140, the input patterns 122, the first output patterns 123, the second output patterns 124, and the bypass patterns 125 may be formed on a surface of the base film 121.

Referring to FIGS. 9A and 9B, in another exemplary embodiment of the present invention, the gate driving semiconductor chip 140 may include a main body 141, a built-in core circuit 144, first input pads 142a which may be formed at a first side of the main body 141, second input pads 142b which may be formed at a second side, and output pads 143 which may be formed at a third side of the main body 141.

The input pads 142a, which may be arranged at the first side of the gate driving semiconductor chip 140, may be connected to the output ends of the input patterns in the group 122a among the input patterns 122. The second input pads 142b, which may be arranged at the second side of the gate driving semiconductor chip 140, may be connected to the input ends of the second output patterns in the group 124a among the second output patterns 124. The output pads 143 may be connected to the first output patterns 123 without being divided.

The first input pads 142a may be electrically connected to the second input pads 142b in one-to-one correspondence. The first input pads 142a and the second input pads 142b may be formed in the same arrangement on opposite sides of the main body, i.e. a mirror structure. A first input pad 142a and a corresponding second input pad 142b, which may be connected by the core circuit 144 incorporated in the gate driving semiconductor chip 140, may output the same type of signal.

First wiring patterns 150 and second wiring patterns 152 may be disposed within the main body 141. The first wiring patterns 150 may input gate driving signals which may be transmitted through the first input pads 142a to the core circuit 144. The second wiring patterns 152 may output gate driving signals, which may not have been processed by the core circuit 144, through the second output pads 142b.

As shown in FIG. 9A, the first wiring patterns 150 may be arranged to turn around the first side of the core circuit 144 in a line, and the second wiring patterns 152 may be arranged to turn around the second side parallel or substantially parallel to the first side of the core circuit 144.

As shown in FIG. 9B, the first wiring patterns 150 may be arranged to be perpendicular or substantially perpendicular to the first side of the core circuit 144, and the second wiring patterns 152 may be arranged to be perpendicular or substantially perpendicular to the second side and parallel or substantially parallel to the first side of the core circuit 144.

In exemplary embodiments of the present invention, the bypass patterns 125 which may be formed on the base film 121, the input patterns 122 and the second output patterns 124, which may be disposed on the base film 121, may be connected within the gate driving semiconductor chip 140 via the first and second wiring patterns 150 and 152 and may be formed within the gate driving semiconductor chip 140. Thus, circuit patterns, the width “l” of the base film 121 shown in FIG. 3, and/or manufacturing costs may be reduced. The first and second input pads 142a and 142b may be divided into a first side and/or a second side of the gate driving semiconductor chip 140, and the width “w” of the gate driving semiconductor chip 140 shown in FIG. 3 may be reduced to a width “w” shown in FIGS. 9A and 9B such that the overall size of the gate driving semiconductor chip 140 may be reduced.

Dividing the input pads into opposite sides may reduce the size of the semiconductor chip. Bypass patterns, which may be formed within the semiconductor chip, may reduce the number of circuit patterns which may pass through a base film, and input and output patterns which may be connected within the semiconductor chip via wiring patterns which may be formed within the semiconductor chip. Using such a semiconductor chip may reduce the size and/or manufacturing costs of the gate TCP and an LCD apparatus.

Although a gate tape circuit substrate (TCP) and a gate board (for example a gate printed circuit board (PCB) or a flexible PCB) may be used as disclosed in exemplary embodiments of the present invention, it will be understood that any board or combination of boards may be used as desired by those skilled in the art.

Although the input pads have been divided into two groups as described in exemplary embodiments of the present invention, it will be understood that the input pads may be divided in any way into any number of groups as desired by those skilled in the art.

Although the wiring layer patterns have been described as bending at an angle of 90 degrees (i.e. turn) around the sides of the main body, core circuit, and the like, by way of exemplary embodiments of the present invention, it will be understood that the wiring layer patterns may bend at any angle as desired by those skilled in the art.

Further, methods of use and methods of manufacture, of the semiconductor chip, the tape carrier package, and the liquid crystal display apparatus would be obvious to one of ordinary skill in the art in view of the exemplary embodiments of the present invention as described above.

While the present invention has been particularly shown and described through exemplary embodiments thereof with reference to the accompanying drawings, it will be understood by those of ordinary skill in the art that various changes in form and details may be made therein without departing from the spirit and scope of the present invention as defined by the following claims.

1. A semiconductor chip comprising:
a main body having a built-in core circuit;
first input pads arranged at a first side of the main body;
second input pads arranged at a second side of the main body;
output pads arranged at a third side of the main body; and
bypass patterns disposed within the main body and transmit driving signals transmitted through the first input pads to the second input pads without passing through the core circuit.

2. The semiconductor chip of claim 1, wherein the second side of the main body is parallel or substantially parallel to the first side of the main body.

3. The semiconductor chip of claim 2, wherein the third side of the main body is perpendicular or substantially perpendicular to the first side of the main body.

4. The semiconductor chip of claim 1, wherein the bypass patterns are arranged parallel or substantially parallel to a fourth side and perpendicular or substantially perpendicular to a first side of the core circuit.

5. The semiconductor chip of claim 1, further comprising:
first wiring patterns formed within the main body to input driving signals transmitted through the first input pads to the core circuit; and
second wiring patterns formed within the main body to output driving signals that have not been processed by the core circuit through the second input pads.

6. The semiconductor chip of claim 3, wherein the first wiring patterns turn around the first side of the core circuit in a line, and the second wiring patterns turn around a second side parallel or substantially parallel to the first side of the core circuit in a line.

7. The semiconductor chip of claim 1, wherein the first input pads are electrically connected to the second input pads in one-to-one correspondence.

8. The semiconductor chip of claim 1, wherein the first wiring patterns are arranged in a line perpendicular or substantially perpendicular to the first side of the core circuit, and the second wiring patterns are arranged in a line perpendicular or substantially perpendicular to a second side and parallel or substantially parallel to the first side of the core circuit.

9. The semiconductor chip of claim 1, wherein the first input pads are electrically connected to the second input pads in one-to-one correspondence.

10. A tape carrier package comprising:
a base film;
a semiconductor chip mounted on the base film, the semiconductor chip including a main body having a built-in core circuit, first input pads arranged at a first side of the main body, second input pads arranged at a second side of the main body, output pads arranged at a third side of the main body, and bypass patterns formed within the main body and transmitting driving signals transmitted through the first input pads to the second input pads without passing through the core circuit;
input patterns formed on the base film to be connected to at least the first input pads of the semiconductor chip;
first output patterns formed on the base film to be connected to at least the output pads of the semiconductor chip; and
second output patterns formed on the base film to be connected to at least the second input pads of the semiconductor chip.

11. The tape carrier package of claim 10, wherein the second side of the main body is parallel or substantially parallel to the first side of the main body.

12. The tape carrier package of claim 10, wherein the third side of the main body is perpendicular or substantially perpendicular to the first side of the main body.

13. The tape carrier package of claim 10, wherein the bypass patterns are arranged in a line parallel or substantially parallel to a fourth side and perpendicular or substantially perpendicular to a first side of the core circuit.

14. The tape carrier package of claim 10, wherein the base film is made of an insulating material.

15. The tape carrier package of claim 10, wherein the semiconductor chip further includes:
first wiring patterns formed within the main body to input driving signals transmitted through the first input pads to the core circuit; and
second wiring patterns formed within the main body to output driving signals that have not been processed by the core circuit through the second input pads.

16. The tape carrier package of claim 10, wherein the first wiring patterns turn around the first side of the core circuit, and the second wiring patterns turn around a second side parallel or substantially parallel to the first side of the core circuit.

17. The tape carrier package of claim 10, wherein the first input pads are electrically connected to the second input pads in one-to-one correspondence.

18. The tape carrier package of claim 10, wherein the first wiring patterns are arranged in a line perpendicular or substantially perpendicular to the first side of the core circuit, and the second wiring patterns are arranged in a line perpendicular or substantially perpendicular to a second side and parallel or substantially parallel to the first side of the core circuit.

19. The tape carrier package of claim 10, wherein the first input pads are electrically connected to the second input pads in one-to-one correspondence.

20. A tape carrier package comprising:
a base film made of an insulating material;
a semiconductor chip mounted on the base film, the semiconductor chip including a main body having a built-in core circuit, first input pads arranged at a first side of the main body, second input pads arranged at a second side parallel or substantially parallel to the first side of the main body, and output pads arranged at a third side perpendicular or substantially perpendicular to the first side of the main body;
the bypass patterns are formed in a line parallel or substantially parallel to a fourth side and perpendicular or substantially perpendicular to the first side of the semiconductor chip;
the input patterns formed on the base film can be connected to the first input pads of the semiconductor chip and one end of the bypass patterns;
the first output patterns formed on the base film can be connected to the output pads of the semiconductor chip; and
the second output patterns formed on the base film can be connected to the second input pads of the semiconductor chip and the other end of the bypass patterns.

21. The tape carrier package of claim 20, wherein the semiconductor chip further includes:
first wiring patterns formed within the main body to input driving signals transmitted through the first input pads to the core circuit; and
second wiring patterns formed within the main body to output driving signals that have not been processed by the core circuit through the second input pads.

22. The tape carrier package of claim 20, wherein the first wiring patterns turn around a first side of the core circuit in a line, and the second wiring patterns turn around a second side parallel or substantially parallel to the first side of the core circuit in a line.

23. The tape carrier package of claim 20, wherein the first input pads are electrically connected to the second input pads in one-to-one correspondence.

24. The tape carrier package of claim 20, wherein the first wiring patterns are arranged in a line perpendicular or substantially perpendicular to a first side of the core circuit, and the second wiring patterns are arranged in a line perpendicular or substantially perpendicular to a second side parallel or substantially parallel to the first side of the core circuit.

25. The tape carrier package of claim 20, wherein the first input pads are electrically connected to the second input pads in one-to-one correspondence.

26. A liquid crystal display apparatus comprising:
a liquid crystal display panel including an upper substrate and a lower substrate including gate lines, data lines, and signal transmission lines for transmitting gate driving signals;
a board, disposed at one side of the liquid crystal display panel which generates gate driving signals and data driving signals;
at least one first tape carrier package, one end of which is connected to the data lines of the lower substrate, and another end of which is connected to the board; and
at least one second tape carrier package, disposed at another side of the liquid crystal display panel, one end of which is connected to the gate lines of the lower substrate the second tape carrier package including a base film; a semiconductor chip mounted on the base film, the semiconductor chip including a main body having a built-in core circuit, first input pads arranged at a first side of the main body, second input pads arranged at a second side of the main body, output pads arranged at a third side of the main body, and bypass patterns formed within the main body and transmitting driving signals transmitted through the first input pads to the second input pads without passing through the core circuit; input patterns formed on the base film to be connected to at least the first input pads of the semiconductor chip; first output patterns formed on the base film to be connected to at least the output pads of the semiconductor chip; and second output patterns formed on the base film to be connected to at least the second input pads of the semiconductor chip.

27. The liquid crystal display apparatus of claim 26, wherein the board is an integrated printed circuit board.

28. The liquid crystal display apparatus claim 26, wherein the at least one second tape carrier package is disposed at a side perpendicular or substantially perpendicular to the side at which the at least one first tape carrier package is disposed.

29. The liquid crystal display apparatus of claim 26, wherein the second side of the main body is parallel or substantially parallel to the first side of the main body.

30. The liquid crystal display apparatus of claim 26, wherein the third side of the main body is perpendicular or substantially perpendicular to the first side of the main body.

31. The liquid crystal display apparatus of claim 26, wherein the bypass patterns are arranged in a line parallel or substantially parallel to a fourth side and perpendicular or substantially perpendicular to a first side of the core circuit.

32. The liquid crystal display apparatus of claim 26, wherein the base film is made of an insulating material.

33. A liquid crystal display apparatus comprising:
a liquid crystal display panel including an upper substrate and a lower substrate including gate lines, data lines, and signal transmission lines for transmitting gate driving signals;
an integrated printed circuit board, disposed at one side of the liquid crystal display panel and generates gate driving signals and data driving signals;
at least one first tape carrier package, one end of which is connected to the data lines of the lower substrate, and another end of which is connected to the integrated printed circuit board; and
at least one second tape carrier package, disposed at another side perpendicular or substantially perpendicular to the side of the liquid crystal display panel, and one end of which is connected to the gate lines of the lower substrate, the second tape carrier package including a base film made of an insulating material; a semiconductor chip mounted on the base film, the semiconductor chip including a main body having a built-in core circuit, first input pads arranged at a first side of the main body, second input pads arranged at a second side parallel or substantially parallel to the first side of the main body, and output pads arranged at a third side perpendicular or substantially perpendicular to the first side of the main body; bypass patterns are formed in a line parallel or substantially parallel to a fourth side and perpendicular or substantially perpendicular to the first side of the semiconductor chip;
the input patterns formed on the base film are connected to the first input pads of the semiconductor chip and one end of the bypass patterns;
the first output patterns formed on the base film are connected to the output pads of the semiconductor chip; and
second output patterns formed on the base film are connected to the second input pads of the semiconductor chip and the other end of the bypass patterns.

34. The liquid crystal display apparatus claim 33, wherein the at least one second tape carrier package is disposed at a side perpendicular or substantially perpendicular to the side at which the at least one first tape carrier package is disposed.

35. The liquid crystal display apparatus of claim 33, wherein the second side of the main body is parallel or substantially parallel to the first side of the main body.

36. The liquid crystal display apparatus of claim 33, wherein the third side of the main body is perpendicular or substantially perpendicular to the first side of the main body.

37. The liquid crystal display apparatus of claim 33, wherein the bypass patterns are arranged in a line parallel or substantially parallel to a fourth side and perpendicular or substantially perpendicular to a first side of the core circuit.
